(19) United States
(12) Patent Application Publication
(10) Pub. No.: US 2026/0038839 A1
(43) Pub. Date: Feb. 5, 2026

(54) METHOD FOR MANUFACTURING COMPOSITE CATHODE PARTICLES BASED ON DUAL-COATED TERNARY OXIDE FOR ELECTROCHEMICAL BATTERY

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 18/792,571

(22) Filed: Aug. 2, 2024

(51) Int. Cl. H01M 4/62; C01G 53/00; H01M 4/02; H01M 4/36; H01M 4/505; H01M 4/525; H01M 10/0562

(52) U.S. Cl. CPC H01M 4/628; C01G 53/44; H01M 4/366; H01M 4/505; H01M 4/525; H01M 10/0562; C01P 2004/61; C01P 2004/86; C01P 2006/40; H01M 2004/028; H01M 2300/0071

(57) ABSTRACT

A method for manufacturing composite cathode particles based on a dual-coated ternary oxide for an electrochemical battery includes the steps of: placing a plurality of large NCM (lithium nickel manganese cobalt oxide) particles and a glass phase material into a first mixer for stirring; then performing a first oxygen assisted sintering on the large NCM particles and the glass phase material mixed by the first mixer to form a plurality of glass-phase-layer-contained NCM particles; then mixing a plurality of small LLZO particles and the glass-phase-layer-contained NCM particles to form a plurality of composite NCM particles; and then performing a second oxygen assisted sintering on the composite NCM particles to form a plurality of sintered powders.

### FIELD OF THE INVENTION

The present invention is related to a cathode material of a battery, and in particular to a method for manufacturing composite cathode particles based on a dual-coated ternary oxide for an electrochemical battery.

### BACKGROUND OF THE INVENTION

A battery is mainly formed by the positive and negative electrodes placed in the electrolyte. The positive electrode is made by mixing and dispersing a large number of positive conductive units (positive electrode material, such as lithium cobalt oxide) in a slurry. The positive conductive units must be mixed with the conductive slurry before being applied to the electrode sheet and assembled into the battery. The positive conductive units are connected to each other through the conductive slurry. Therefore, the conductive slurry must have enough conductivity in order to enable free electrons to migrate in different positive conductive units and do not have to consume too much energy due to the internal resistance, which achieves the purpose of effective conductivity. As a result, it is necessary to use a specific conductive material to make the slurry to adjust the conductivity.

In order to increase the conductivity, the positive electrode slurry is filled with a plurality of positive electrode particles which may be formed by NCM (lithium nickel manganese cobalt oxide), LMFP (lithium manganese iron phosphate), or mixtures thereof. The positive electrode particles are distributed within the positive electrode slurry. However, in prior arts, the interface of the positive electrode particles is prone to produce side reactions that reduce the lifespan of the positive electrode and lower the electronic conductivity, so the overall battery performance is also poor.

### SUMMARY OF THE INVENTION

Accordingly, for improving above mentioned defects in the prior art, the object of the present invention is to provide a method for manufacturing composite cathode particles based on a dual-coated ternary oxide for an electrochemical battery, wherein an outer surface of each of the large NCM particles is enclosed by a glass phase layer. The glass phase layer serves to block a direct contact between the large NCM particle and the electrolyte of the battery and reduce the interface side reaction. The glass phase layer serves to reduce an interface impedance of lithium ions entering and exiting the large NCM particle and improve a charge-discharge rate performance. The glass phase layer also serves to accommodate a volumetric change of a charging and discharging and improve mechanical properties of the large NCM particle, and reduce the fragmentation. The small LLZO particles distributed on the glass phase layer have the ability of accommodating and guiding the lithium ions. When the lithium ions pass through the positive electrode, conducting paths of the lithium ions are dispersed by the guiding of the distributed small LLZO particles, which results in better conducting paths for the lithium ions. The present invention further uses the first carbon nanotubes and nanoscale amorphous carbons to enclose the outer side of the large NCM particle having the small LLZO particles for conducting the electron. The nanoscale amorphous carbons are filled between the first carbon nanotubes to form a more complete electron conduction path. Therefore, the present invention can improve the stability of the positive electrode and reduce the use of cobalt.

To achieve above object, the present invention provides a method for manufacturing composite cathode particles based on a dual-coated ternary oxide for an electrochemical battery, wherein the electrochemical battery is a solid-state battery or semi-solid battery; the composite cathode particles are a plurality of positive electrode particles which are used in a positive electrode inside the electrochemical battery; the method comprising the following steps of: step A: taking an NCM (lithium nickel manganese cobalt oxide) material which is formed by a plurality of large NCM particles, wherein each of the large NCM particles is a cube having an irregular shape; then placing the large NCM particles and a glass phase material into a first mixer for stirring to uniformly mix the large NCM particles and the glass phase material; wherein the glass phase material is formed by a first material which is an amorphous oxide or a non-oxide solid-state electrolyte; and a lithium ion conductivity of the first material is higher than 10⁻⁵ S/cm (Siemens per centimeter); step B: performing a first oxygen assisted sintering on the large NCM particles and the glass phase material mixed by the first mixer to form a plurality of glass-phase-layer-contained NCM particles; wherein after the first oxygen assisted sintering, each of the glass-phase-layer-contained NCM particles includes a corresponding large NCM particle and a glass phase layer which is formed by the glass phase material and is partially or fully coated on an outer surface of the corresponding large NCM particle; wherein the glass phase layer serves to block a direct contact between the corresponding large NCM particle and the electrolyte of the battery and reduce an interface side reaction; and the glass phase layer serves to reduce an interface impedance of lithium ions entering and exiting the corresponding large NCM particle; step C: mixing a LLZO material and the glass-phase-layer-contained NCM particles to form a plurality of composite NCM particles, wherein the LLZO material is formed by a plurality of small LLZO particles; a size of each of the large NCM particles is larger than a size of each of the small LLZO particles; each of the small LLZO particles is formed by a LLZO (lithium lanthanum zirconium oxide, Li₇La₃Zr₂O₁₂) or a LLZO doped with at least one metal; the glass-phase-layer-contained NCM particles and the small LLZO particles are placed into a second mixer to be stirred and uniformly mixed; after the stirring of the second mixer, each of the small LLZO particles are dispersed within the glass phase layer or on a surface of the glass phase layer of the corresponding glass-phase-layer-contained NCM particle; and each of the glass-phase-layer-contained NCM particles and the corresponding small LLZO particles on the glass-phase-layer-contained NCM particle form a corresponding composite NCM particle; and step D: performing a second oxygen assisted sintering on the composite NCM particles to form a plurality of sintered powders; wherein the second oxygen assisted sintering serves to eliminate the interface impedance between the small LLZO particles and the corresponding large NCM particle during the transferring of the lithium ions; step E: performing a carbon material mixing on the sintered powders, a plurality of first carbon nanotubes and a plurality of nanoscale amorphous carbons for mixing the sintered powders, the first carbon nanotubes and the nanoscale amorphous carbons to form a plurality of carbon-material-contained positive electrode particles.

### BRIEF DESCRIPTION OF THE DRAWINGS

FIG. 1 is a steps flow diagram showing the process of the present invention.

FIG. 2 is a schematic view showing the structure of the positive electrode particle of the present invention.

FIG. 3 is a schematic view showing the structure of the positive electrode of the present invention.

FIG. 4 is a schematic view showing the structure of the composite NCM particle of the present invention.

FIG. 5 is a schematic view showing the structure of the composite NCM particle and the short chain carbon nanotubes of the present invention.

FIG. 6 is a schematic view showing the structure of the carbon-nanotube-contained positive electrode particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

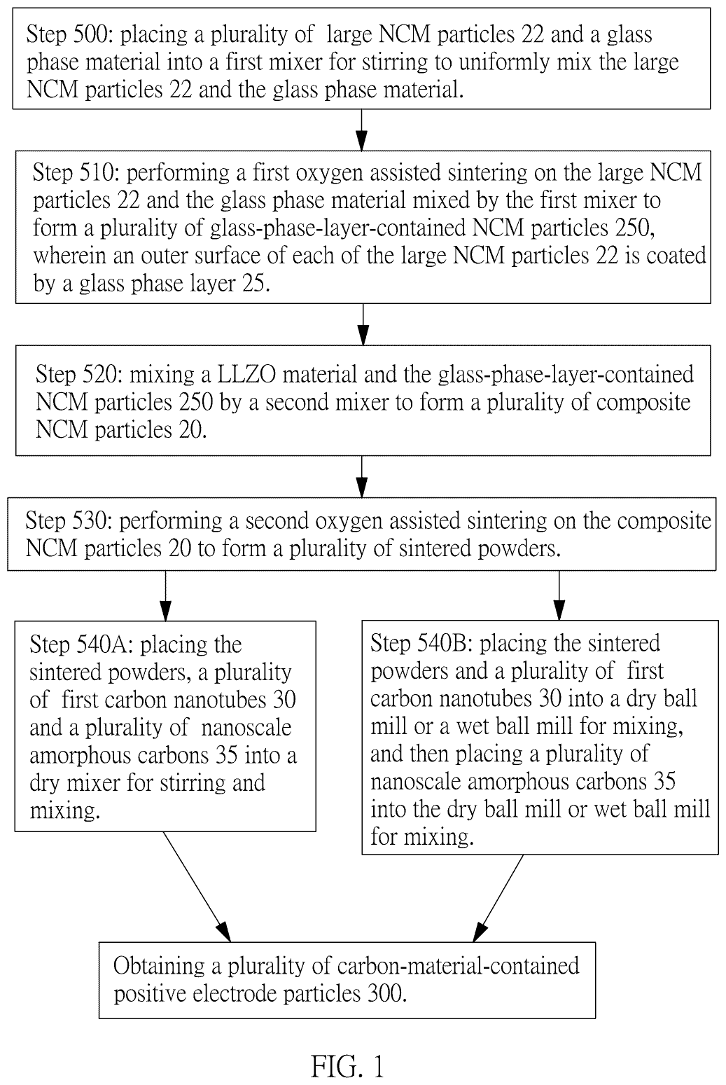

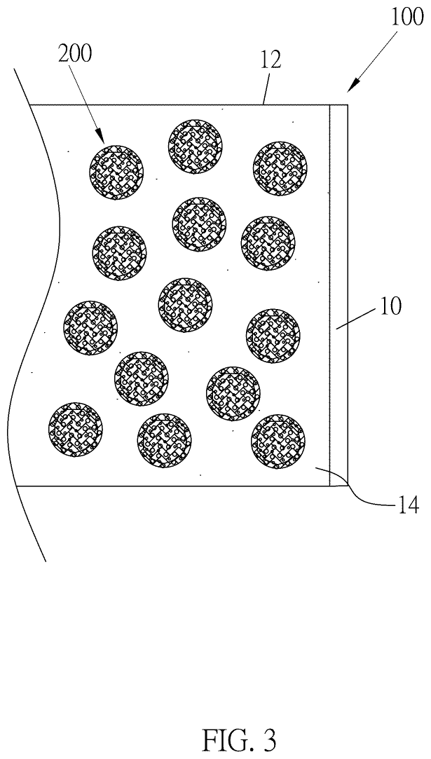

With reference to FIGS. 1 to 6, the present invention provides a method for manufacturing composite cathode particles based on a dual-coated ternary oxide for an electrochemical battery, wherein the electrochemical battery is in particular a solid-state battery or semi-solid battery. The composite cathode particles are a plurality of positive electrode particles 200 which are used in a positive (+) electrode 100 inside the electrochemical battery. The positive electrode 100 includes a positive substrate 10 and a positive slurry layer 12 coated on the positive substrate 10. The positive slurry layer 12 includes the positive electrode particles 200 and a positive slurry 14 with a binder (as shown in FIG. 3). The binder may be PVDF (polyvinylidene difluoride) or PEO (polyethylene oxide). A weight percentage of the positive particles 200 in the positive slurry layer 12 is 92 wt %˜98 wt %.

The method of the present invention is used to manufacture the positive electrode particles 200, that is, the composite cathode particles. Referring to FIG. 1, the method of the present invention comprises the following steps of:

Step 500: taking an NCM (lithium nickel manganese cobalt oxide) material which is formed by a plurality of large NCM particles 22. NCM is a ternary oxide. A size of each of the large NCM particles 22 is 3 μm to 5 μm. Each of the large NCM particles 22 is a single crystal and is a cube having an irregular shape. Then placing the large NCM particles 22 and a glass phase material into a first mixer for stirring to uniformly mix the large NCM particles 22 and the glass phase material. The first mixer is selected from a dry mixer (such as a three dimensional mixer or a flat roller mixer) or a wet mixer (such as a direct current blade mixer). An anhydrous alcohol and an isopropyl alcohol solvent are added into the wet mixer. A stirring rotation speed of the first mixer is 20 rpm˜500 rpm. A stirring time of the first mixer is 2˜12 hours.

The glass phase material is formed by a first material which is an amorphous oxide or a non-oxide solid-state electrolyte. A lithium ion conductivity of the first material is higher than 10⁻⁵ S/cm (Siemens per centimeter). The first material is selected from at least one of “an oxide formed by a lithium (Li) and a chemical element in group IIIA (boron group), group IVA (carbon group) or group VA (nitrogen group) of a periodic table” (such as Li₂O—ROₓ, wherein R is selected from at least one of a boron (B), aluminum (Al), silicon (Si), germanium (Ge), phosphorus (P) and arsenic (As), and x=1˜3), an amorphous oxide-based solid-state electrolyte (such as an amorphous perovskite solid-state electrolyte (Li—La—Ti—O, lithium lanthanum titanium oxide, LLTO)), a garnet-based solid-state electrolyte (such as Li—La—Zr—O, lithium lanthanum zirconium oxide, LLZO), and a lithium phosphorus oxynitride (LiPON).

Step 510: performing a first oxygen assisted sintering on the large NCM particles 22 and the glass phase material mixed by the first mixer to form a plurality of glass-phase-layer-contained NCM particles 250. A first sintering temperature of the first oxygen assisted sintering is 250° C.˜650° C. The first sintering temperature is increased at a rate of 1.5° C. to 5° C. per minute and is hold for 0.5 to 4 hours after reaching a maximum temperature. After the first oxygen assisted sintering, each of the glass-phase-layer-contained NCM particles 250 includes a corresponding large NCM particle 22 and a glass phase layer 25 which is formed by the glass phase material and is partially or fully coated on (or encloses) an outer surface of the corresponding large NCM particle 22. A thickness of the glass phase layer 25 is 5 nm˜100 nm.

The glass phase layer 25 serves to block a direct contact between the corresponding large NCM particle 22 and the electrolyte of the battery and reduce the interface side reaction. The glass phase layer 25 serves to reduce an interface impedance of lithium ions entering and exiting the corresponding large NCM particle 22 and improve a rate capability performance. The glass phase layer 25 also serves to accommodate a volumetric change of a charging and discharging and improve mechanical properties of the corresponding large NCM particle 22, and reduce the fragmentation.

Step 520: mixing a LLZO material and the glass-phase-layer-contained NCM particles 250 to form a plurality of composite NCM particles 20, wherein the LLZO material is formed by a plurality of small LLZO particles 24. Each of the small LLZO particles 24 is formed by a LLZO (lithium lanthanum zirconium oxide, Li₇La₃Zr₂O₁₂) or a LLZO doped with at least one metal. The LLZO doped with at least one metal may be a gallium (Ga)-doped LLZO (Li_{6.2}Ga_{0.8}La₃Zr₂O₁₂), an aluminum (Al)-doped LLZO or a barium (Ba)-doped LLZO. The size of each of the large NCM particles 22 is larger than a size of each of the small LLZO particles 24. A maximum radial size of each of the LLZO fine particles 24 is less than 40 nm.

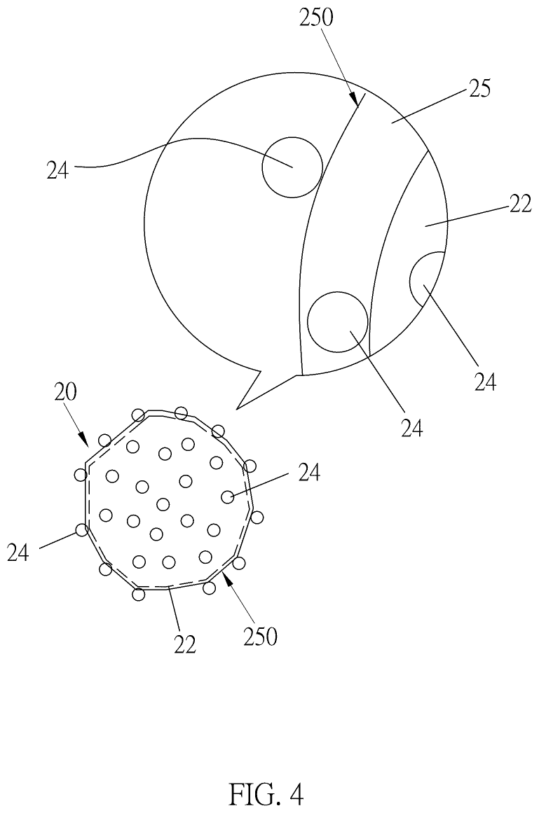

The glass-phase-layer-contained NCM particles 250 and the small LLZO particles 24 are placed into a second mixer (such as a three dimensional mixer or a flat roller mixer) to be stirred and uniformly mixed. A stirring rotation speed of the first mixer is 20 rpm˜500 rpm. A stirring time of the second mixer is 2˜12 hours. After the stirring of the second mixer, each of the small LLZO particles 24 is dispersed within the glass phase layer 25 or on a surface of the glass phase layer 25 of the corresponding glass-phase-layer-contained NCM particle 250. Each of the glass-phase-layer-contained NCM particles 250 and the corresponding small LLZO particles 24 on the glass-phase-layer-contained NCM particle 250 form a corresponding composite NCM particle 20 (as shown in FIG. 4).

Preferably, each of the small LLZO particles 24 is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

Preferably, each of the small LLZO particles 24 is formed by a Cuₐ,X_{b}-LLZO, which is a LLZO doped with copper (Cu) and a metal X, wherein X is selected from gallium (Ga), tantalum (Ta), strontium (Sr), barium (Ba) and aluminum (Al), and a>0 and b>0. Preferably, a+b=0.25˜0.8 and a>0.1. Doping the copper in the LLZO is technically difficult, but Cuₐ,X_{b}-LLZO can stabilize an overall structure of the composite NCM particle 20, smooth the channels for lithium ions, and increase a speed of the sintering (referring to the following second oxygen assisted sintering), which makes the cost more cheaper. It also reduces the producing of lithium carbonate (Li₂CO₃) when the small LLZO particles 24 are exposed to the air, which increases the surface stability of the small LLZO particles 24 during the sintering (referring to the following second oxygen assisted sintering).

In each of the composite NCM particles 20, a ratio of a total weight of the corresponding small LLZO particles 24 and a weight of the corresponding glass-phase-layer-contained NCM particle 250 is 0.2%˜2%.

Step 530: performing a second oxygen assisted sintering on the composite NCM particles 20 to form a plurality of sintered powders. A second sintering temperature of the first oxygen assisted sintering is 550° C.˜650° C. The second sintering temperature is increased at a rate of 1.5° C. to 5° C. per minute and is hold for 0.5 to 2 hours after reaching a maximum temperature. The second oxygen assisted sintering serves to eliminate the interface impedance between the small LLZO particles 24 and the corresponding large NCM particle 22 during the transferring of the lithium ions. The sintered composite NCM particle 20 forms the dual-coated ternary oxide of the present invention.

After the second oxygen assisted sintering, a horizontal size of each of the small LLZO particles 24 is 50 nm˜300 nm, which is a size of the small LLZO particle 24 on a horizontal direction corresponding to a spherical surface of the corresponding large NCM particle 22. Basically, after the second oxygen assisted sintering, the horizontal size of each of the small LLZO particles 24 is increased. A vertical size of each of the small LLZO particles 24 is decreased, wherein the vertical size of the small LLZO particle 24 is a size on a direction perpendicular to the horizontal direction corresponding to the spherical surface of the corresponding large NCM particle 22. A volume of each of the small LLZO particles 24 remains unchanged. Each of the small LLZO particles 24 is fixed on the corresponding glass phase layer 25 after the second oxygen assisted sintering.

Then performing a carbon material mixing on the sintered powders, a plurality of first carbon nanotubes 30 and a plurality of nanoscale amorphous carbons 35 for mixing the sintered powders, the first carbon nanotubes 30 and the nanoscale amorphous carbons 35 to form a plurality of carbon-material-contained positive electrode particles 300. The carbon material mixing can be performed by the following two ways.

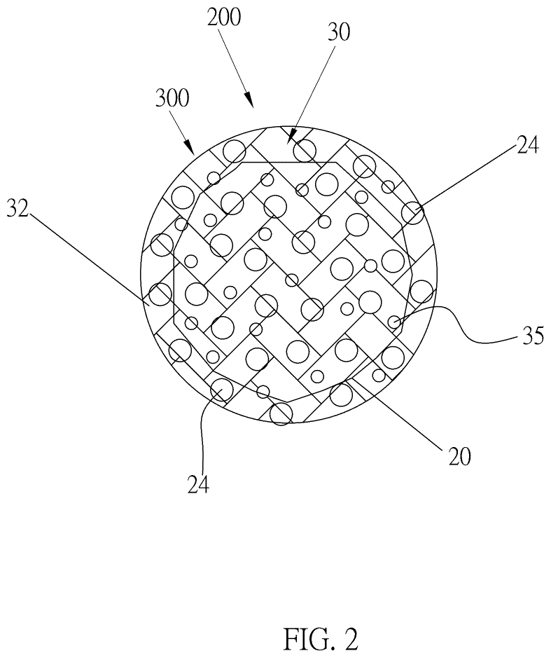

The first way of the carbon material mixing is performed by step 540A: placing the sintered powders, the first carbon nanotubes 30 and the nanoscale amorphous carbons 35 into a dry mixer (such as a planetary mixer or a tumbler mixer) for stirring and mixing to form the carbon-material-contained positive electrode particles 300. Each of the carbon-material-contained positive electrode particles 300 includes a corresponding composite NCM particle 20, a plurality of corresponding first carbon nanotubes 30 and a plurality of corresponding nanoscale amorphous carbons 35. The corresponding first carbon nanotubes 30 and the corresponding nanoscale amorphous carbons 35 enclose (or are coated on) an outer side of the corresponding composite NCM particle 20 (as shown in FIG. 2). A stirring rotation speed of the dry mixer is 50 rpm˜500 rpm. A stirring time of the dry mixer is 2˜8 hours.

Preferably, the nanoscale amorphous carbons 35 are amorphous carbons of a Super P auxiliary agent. A size of each of the nanoscale amorphous carbons 35 is 20 nm˜100 nm. In each of the carbon-material-contained positive electrode particles 300, the corresponding nanoscale amorphous carbons 35 are filled in a plurality of gaps of an interleaving structure formed by the corresponding first carbon nanotubes 30 (as shown in FIG. 2). In each of the carbon-material-contained positive electrode particles 300, a ratio of a total weight of the corresponding nanoscale amorphous carbons 35 and the weight of the corresponding composite NCM particle 20 is 0.1%˜2%.

The second way of the carbon material mixing is performed by step 540B: performing a first mixing for mixing the first carbon nanotubes 30 and the sintered powders to form a first mixture, and then performing a second mixing for mixing the first mixture and the nanoscale amorphous carbons 35 to form the carbon-material-contained positive electrode particles 300. Each of the carbon-material-contained positive electrode particles 300 includes a corresponding composite NCM particle 20, a plurality of corresponding first carbon nanotubes 30 and a plurality of corresponding nanoscale amorphous carbons 35. The corresponding first carbon nanotubes 30 and the corresponding nanoscale amorphous carbons 35 enclose (are coated on) an outer side of the corresponding composite NCM particle 20.

The first mixing and the second mixing are performed by a dry ball milling mixing or a wet ball milling mixing.

When the first mixing and the second mixing are performed by the dry ball milling mixing, the first carbon nanotubes 30 and the sintered powders are first placed into a dry ball mill for performing the first mixing through a ball milling to form the first mixture. Then the nanoscale amorphous carbons 35 are placed into the dry ball mill for performing the second mixing through the ball milling to mix the nanoscale amorphous carbons 35 with the first mixture to form the carbon-material-contained positive electrode particles 300. In the first mixing and the second mixing, a rotation speed of the dry ball mill is 50 rpm˜1000 rpm. A mixing time of the dry ball mill is between 20 minutes to 12 hours. A mixing temperature of the dry ball mill is between a room temperature and 50° C.

When the first mixing and the second mixing are performed by the wet ball milling mixing, the first carbon nanotubes 30 are first dispersed in a dispersant, then the sintered powders and the dispersant having the first carbon nanotubes 30 are placed into a wet ball mill for performing the first mixing through the wet ball milling to form the first mixture. Then the nanoscale amorphous carbons 35 are placed into the wet ball mill for performing the second mixing through the wet ball milling to mix the nanoscale amorphous carbons 35 with the first mixture to form the carbon-material-contained positive electrode particles 300. In the first mixing and the second mixing, a rotation speed of the wet ball mill is 50 rpm˜500 rpm. A mixing time of the wet ball mill is between 20 minutes to 12 hours. The dispersant is a polarized or nonpolar non-aqueous organic solvent.

In the step 540B, the dry ball milling mixing or the wet ball milling mixing is used to form the carbon-material-contained positive electrode particles 300.

The first carbon nanotubes 30 include a plurality of short chain carbon nanotubes 32 and a plurality of long chain carbon nanotubes 34. A length of each of the short chain carbon nanotubes 32 is 0.5 μm to 1 μm. A length of each of the long chain carbon nanotubes 34 is 3 μm to 8 μm. In each of the carbon-material-contained positive electrode particles 300, a ratio of a total weight of the corresponding first carbon nanotubes 30 and a weight of the corresponding composite NCM particle 20 is 0.1%˜2%.

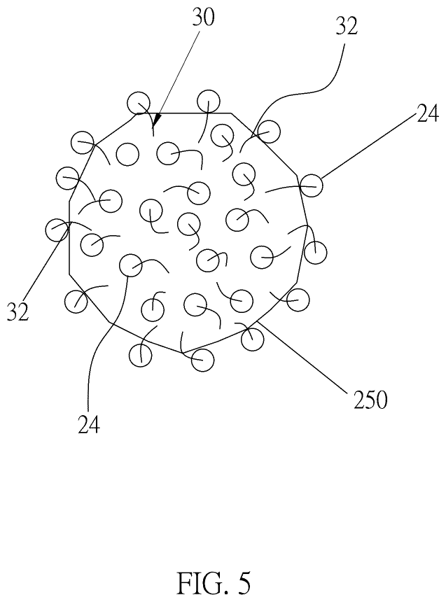

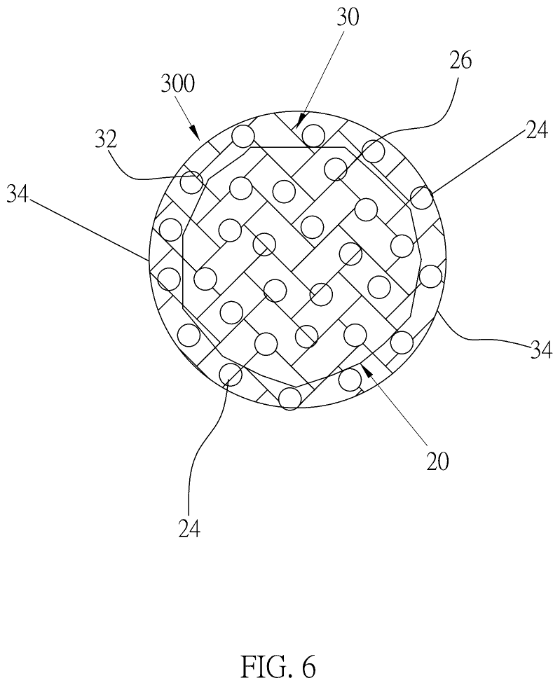

The first carbon nanotubes 30 have various lengths to form a plurality of connections with different spanning lengths on each of the composite NCM particles 20, which increases the conductivity of the positive electrode 100. Referring to FIGS. 5 and 6, each of the short chain carbon nanotubes 32 is connected across between the corresponding small LLZO particle 24 and the corresponding large NCM particle 22. The long chain carbon nanotubes 34 wrap (or enclose) each of the composite NCM particles 20 to enhance a structural strength of the composite NCM particles 20. A carbon nanotube is a very good conductive material, which increases the electrical conductivity of the entire positive electrode 100. Each of the composite NCM particles 20 wrapped by the corresponding first carbon nanotubes 30 forms a hairball-like structure.

The first carbon nanotubes 30 serve to increase the electrical conductance of the electron by forming a plurality of conductive bridges between the small LLZO particles 24 for conducting the electron on the composite NCM particle 20. The first carbon nanotubes 30 have an extremely high electrical conductivity, so that the lithium ions can pass through the first carbon nanotubes 30 and conduct between the small LLZO particles 24 and the large NCM particle 22, which increases the electrical conductivity of the positive electrode 100.

The first carbon nanotubes 30 and the nanoscale amorphous carbons 35 are used as an auxiliary agent. Because the nanoscale amorphous carbons 35 are in a form of particles, and the first carbon nanotubes 30 are in a form of long strips, the gaps are formed in the interleaving structure formed by the corresponding first carbon nanotubes 30 on each of the composite NCM particles 20, and the gaps are unable to conduct the electric current. Therefore, the nanoscale amorphous carbons 35 is filled in the gaps to transmit the electric charge the first carbon nanotubes 30 through the spanning of the nanoscale amorphous carbons 35, which further increases the transmitting efficiency of the electric current.

In each of the carbon-material-contained positive electrode particles 300, a ratio of a total weight of the corresponding first carbon nanotubes 30 and the corresponding nanoscale amorphous carbons 35 and the weight of the corresponding composite NCM particle 20 is (0.09˜3):100.

In each of the carbon-material-contained positive electrode particles 300, a ratio of a total weight of the corresponding first carbon nanotubes 30, a total weight of the corresponding nanoscale amorphous carbons 35, and the weight of the corresponding composite NCM particle 20 is 0.5:1:100.

A size of each of the nanoscale amorphous carbons 35 is 20 nm˜100 nm.

The advantages of the first carbon nanotubes 30 are that the lithium ions are easy to be stabilized between the first carbon nanotubes 30, therefore the positive slurry layer 12 can be used to stable the lithium ions and electron between the short chain carbon nanotubes 32 and the long chain carbon nanotubes 34 to increases the lithium ion conductivity. The very high lithium ion conductivity helps the whole battery to charge and discharge quickly. In addition, the use of cobalt also can be reduced, so that the overall production cost can be reduced.

The advantages of the present invention are that an outer surface of each of the large NCM particles is enclosed by a glass phase layer. The glass phase layer serves to block a direct contact between the large NCM particle and the electrolyte of the battery and reduce the interface side reaction. The glass phase layer serves to reduce an interface impedance of lithium ions entering and exiting the large NCM particle and improve a charge-discharge rate performance. The glass phase layer also serves to accommodate a volumetric change of a charging and discharging and improve mechanical properties of the large NCM particle, and reduce the fragmentation. The small LLZO particles distributed on the glass phase layer have the ability of accommodating and guiding the lithium ions. When the lithium ions pass through the positive electrode, conducting paths of the lithium ions are dispersed by the guiding of the distributed small LLZO particles, which results in better conducting paths for the lithium ions. The present invention further uses the first carbon nanotubes and nanoscale amorphous carbons to enclose the outer side of the large NCM particle having the small LLZO particles for conducting the electron. The nanoscale amorphous carbons are filled between the first carbon nanotubes to form a more complete electron conduction path. Therefore, the present invention can improve the stability of the positive electrode and reduce the use of cobalt.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing composite cathode particles based on a dual-coated ternary oxide for an electrochemical battery, wherein the electrochemical battery is a solid-state battery or semi-solid battery; the composite cathode particles are a plurality of positive electrode particles which are used in a positive electrode inside the electrochemical battery; the method comprising the following steps of:
step A: taking an NCM (lithium nickel manganese cobalt oxide) material which is formed by a plurality of large NCM particles, wherein each of the large NCM particles is a cube having an irregular shape; then placing the large NCM particles and a glass phase material into a first mixer for stirring to uniformly mix the large NCM particles and the glass phase material; wherein the glass phase material is formed by a first material which is an amorphous oxide or a non-oxide solid-state electrolyte; and a lithium ion conductivity of the first material is higher than 10⁻⁵ S/cm (Siemens per centimeter);
step B: performing a first oxygen assisted sintering on the large NCM particles and the glass phase material mixed by the first mixer to form a plurality of glass-phase-layer-contained NCM particles; wherein after the first oxygen assisted sintering, each of the glass-phase-layer-contained NCM particles includes a corresponding large NCM particle and a glass phase layer which is formed by the glass phase material and is partially or fully coated on an outer surface of the corresponding large NCM particle; wherein the glass phase layer serves to block a direct contact between the corresponding large NCM particle and the electrolyte of the battery and reduce an interface side reaction; and the glass phase layer serves to reduce an interface impedance of lithium ions entering and exiting the corresponding large NCM particle;
step C: mixing a LLZO material and the glass-phase-layer-contained NCM particles to form a plurality of composite NCM particles, wherein the LLZO material is formed by a plurality of small LLZO particles; a size of each of the large NCM particles is larger than a size of each of the small LLZO particles; each of the small LLZO particles is formed by a LLZO (lithium lanthanum zirconium oxide, Li₇La₃Zr₂O₁₂) or a LLZO doped with at least one metal; the glass-phase-layer-contained NCM particles and the small LLZO particles are placed into a second mixer to be stirred and uniformly mixed; after the stirring of the second mixer, each of the small LLZO particles are dispersed within the glass phase layer or on a surface of the glass phase layer of the corresponding glass-phase-layer-contained NCM particle; and each of the glass-phase-layer-contained NCM particles and the corresponding small LLZO particles on the glass-phase-layer-contained NCM particle form a corresponding composite NCM particle; and
step D: performing a second oxygen assisted sintering on the composite NCM particles to form a plurality of sintered powders; wherein the second oxygen assisted sintering serves to eliminate the interface impedance between the small LLZO particles and the corresponding large NCM particle during the transferring of the lithium ions.

2. The method for manufacturing the composite cathode particles based on the dual-coated ternary oxide for the electrochemical battery as claimed in claim 1, wherein the size of each of the large NCM particles is 3 μm to 5 μm; each of the large NCM particles is a single crystal; a thickness of the glass phase layer is 5 nm˜100 nm; and a maximum radial size of each of the LLZO fine particles is less than 40 nm.

3. The method for manufacturing the composite cathode particles based on the dual-coated ternary oxide for the electrochemical battery as claimed in claim 1, wherein in the step A, the first mixer is selected from a three dimensional mixer, a flat roller mixer, and a direct current blade mixer; and an anhydrous alcohol and an isopropyl alcohol solvent are added into the direct current blade mixer.

4. The method for manufacturing the composite cathode particles based on the dual-coated ternary oxide for the electrochemical battery as claimed in claim 1, wherein the first material is selected from at least one of “an oxide formed by a lithium (Li) and a chemical element in group IIIA (boron group), group IVA (carbon group) or group VA (nitrogen group) of a periodic table”, an amorphous oxide-based solid-state electrolyte, an amorphous perovskite solid-state electrolyte, a garnet-based solid-state electrolyte, and a lithium phosphorus oxynitride.

5. The method for manufacturing the composite cathode particles based on the dual-coated ternary oxide for the electrochemical battery as claimed in claim 1, wherein the first material is selected from at least one of:
Li₂O—ROₓ, wherein R is selected from at least one of a boron (B), aluminum (Al), silicon (Si), germanium (Ge), phosphorus (P) and arsenic (As), and x=1˜3;
LLTO (Li—La—Ti—O, lithium lanthanum titanium oxide);
LLZO (Li₇La₃Zr₂O₁₂, lithium lanthanum zirconium oxide); and
LiPON (lithium phosphorus oxynitride).

6. The method for manufacturing the composite cathode particles based on the dual-coated ternary oxide for the electrochemical battery as claimed in claim 1, wherein in the step A, a first sintering temperature of the first oxygen assisted sintering is 250° C.˜650° C.; and the first sintering temperature is increased at a rate of 1.5° C. to 5° C. per minute and is hold for 0.5 to 4 hours after reaching a maximum temperature.

7. The method for manufacturing the composite cathode particles based on the dual-coated ternary oxide for the electrochemical battery as claimed in claim 1, wherein each of the small LLZO particles is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

8. The method for manufacturing the composite cathode particles based on the dual-coated ternary oxide for the electrochemical battery as claimed in claim 1, wherein each of the small LLZO particles is formed by a Cuₐ,X_{b}-LLZO, which is a LLZO doped with copper (Cu) and a metal X, wherein X is selected from gallium (Ga), tantalum (Ta), strontium (Sr), barium (Ba) and aluminum (Al), and a+b=0.25˜0.8 and a>0.1; the Cuₐ,X_{b}-LLZO serves to stabilize the composite NCM particle, smooth channels for lithium ions, and increase a speed of the second oxygen assisted sintering, which makes the cost more cheaper; the Cuₐ,X_{b}-LLZO also serves to reduce the producing of lithium carbonate (Li₂CO₃) when the small LLZO particles are exposed to the air, which increases a surface stability of the small LLZO particles during the second oxygen assisted sintering.

9. The method for manufacturing the composite cathode particles based on the dual-coated ternary oxide for the electrochemical battery as claimed in claim 1, wherein in each of the composite NCM particles, a ratio of a total weight of the corresponding small LLZO particles and a weight of the corresponding glass-phase-layer-contained NCM particle is 0.2%˜2%.

10. The method for manufacturing the composite cathode particles based on the dual-coated ternary oxide for the electrochemical battery as claimed in claim 1, wherein in the step C, a stirring rotation speed of the first mixer is 20 rpm˜500 rpm; and a stirring time of the second mixer is 2˜12 hours; and
wherein in the step D, a second sintering temperature of the first oxygen assisted sintering is 550° C.˜650° C.; and the second sintering temperature is increased at a rate of 1.5° C. to 5° C. per minute and is hold for 0.5 to 2 hours after reaching a maximum temperature.

11. The method for manufacturing the composite cathode particles based on the dual-coated ternary oxide for the electrochemical battery as claimed in claim 1, further comprising the following steps of:
step E: performing a carbon material mixing on the sintered powders, a plurality of first carbon nanotubes and a plurality of nanoscale amorphous carbons for mixing the sintered powders, the first carbon nanotubes and the nanoscale amorphous carbons to form a plurality of carbon-material-contained positive electrode particles.

12. The method for manufacturing the composite cathode particles based on the dual-coated ternary oxide for the electrochemical battery as claimed in claim 11, wherein the carbon material mixing is performed by placing the sintered powders, the first carbon nanotubes and the nanoscale amorphous carbons into a dry mixer for stirring and mixing to form the carbon-material-contained positive electrode particles; wherein each of the carbon-material-contained positive electrode particles includes a corresponding composite NCM particle, a plurality of corresponding first carbon nanotubes and a plurality of corresponding nanoscale amorphous carbons; the corresponding first carbon nanotubes and the corresponding nanoscale amorphous carbons enclose an outer side of the corresponding composite NCM particle; a stirring rotation speed of the dry mixer is 50 rpm˜500 rpm; and a stirring time of the dry mixer is 2˜8 hours.

13. The method for manufacturing the composite cathode particles based on the dual-coated ternary oxide for the electrochemical battery as claimed in claim 11, wherein the carbon material mixing is performed by performing a first mixing for mixing the first carbon nanotubes and the sintered powders to form a first mixture, and then performing a second mixing for mixing the first mixture and the nanoscale amorphous carbons to form the carbon-material-contained positive electrode particles; wherein each of the carbon-material-contained positive electrode particles includes a corresponding composite NCM particle, a plurality of corresponding first carbon nanotubes and a plurality of corresponding nanoscale amorphous carbons; the corresponding first carbon nanotubes and the corresponding nanoscale amorphous carbons enclose an outer side of the corresponding composite NCM particle; and the first mixing and the second mixing are performed by a dry ball milling mixing or a wet ball milling mixing.

14. The method for manufacturing the composite cathode particles based on the dual-coated ternary oxide for the electrochemical battery as claimed in claim 13, wherein the first mixing and the second mixing are performed by the dry ball milling mixing; wherein the first carbon nanotubes and the sintered powders are first placed into a dry ball mill for performing the first mixing through a ball milling to form the first mixture; then the nanoscale amorphous carbons are placed into the dry ball mill for performing the second mixing through the ball milling to mix the nanoscale amorphous carbons with the first mixture to form the carbon-material-contained positive electrode particles; in the first mixing and the second mixing, a rotation speed of the dry ball mill is 50 rpm˜1000 rpm; a mixing time of the dry ball mill is between 20 minutes to 12 hours; and a mixing temperature of the dry ball mill is between a room temperature and 50° C.

15. The method for manufacturing the composite cathode particles based on the dual-coated ternary oxide for the electrochemical battery as claimed in claim 13, wherein the first mixing and the second mixing are performed by the wet ball milling mixing; the first carbon nanotubes are first dispersed in a dispersant, then the sintered powders and the dispersant having the first carbon nanotubes are placed into a wet ball mill for performing the first mixing through the wet ball milling to form the first mixture; then the nanoscale amorphous carbons are placed into the wet ball mill for performing the second mixing through the wet ball milling to mix the nanoscale amorphous carbons with the first mixture to form the carbon-material-contained positive electrode particles; in the first mixing and the second mixing, a rotation speed of the wet ball mill is 50 rpm˜500 rpm; a mixing time of the wet ball mill is between 20 minutes to 12 hours; and the dispersant is a polarized or nonpolar non-aqueous organic solvent.

16. The method for manufacturing the composite cathode particles based on the dual-coated ternary oxide for the electrochemical battery as claimed in claim 11, wherein a size of each of the nanoscale amorphous carbons is 20 nm˜100 nm; in each of the carbon-material-contained positive electrode particles, the corresponding nanoscale amorphous carbons are filled in a plurality of gaps of an interleaving structure formed by the corresponding first carbon nanotubes; and in each of the carbon-material-contained positive electrode particles, a ratio of a total weight of the corresponding nanoscale amorphous carbons and the weight of the corresponding composite NCM particle is 0.1%˜2%.

17. The method for manufacturing the composite cathode particles based on the dual-coated ternary oxide for the electrochemical battery as claimed in claim 11, wherein the first carbon nanotubes include a plurality of short chain carbon nanotubes and a plurality of long chain carbon nanotubes; a length of each of the short chain carbon nanotubes is 0.5 μm to 1 μm; a length of each of the long chain carbon nanotubes is 3 μm to 8 μm; each of the short chain carbon nanotubes is connected across between the corresponding small LLZO particle and the corresponding large NCM particle; and the long chain carbon nanotubes wrap each of the composite NCM particles to enhance a structural strength of the composite NCM particles.

18. The method for manufacturing the composite cathode particles based on the dual-coated ternary oxide for the electrochemical battery as claimed in claim 11, wherein in each of the carbon-material-contained positive electrode particles, a ratio of a total weight of the corresponding first carbon nanotubes and a weight of the corresponding composite NCM particle is 0.1%˜2%.

19. The method for manufacturing the composite cathode particles based on the dual-coated ternary oxide for the electrochemical battery as claimed in claim 11, wherein in each of the carbon-material-contained positive electrode particles, a ratio of a total weight of the corresponding first carbon nanotubes and the corresponding nanoscale amorphous carbons and the weight of the corresponding composite NCM particle is (0.09˜3):100.

20. The method for manufacturing the composite cathode particles based on the dual-coated ternary oxide for the electrochemical battery as claimed in claim 11, wherein in each of the carbon-material-contained positive electrode particles, a ratio of a total weight of the corresponding first carbon nanotubes, a total weight of the corresponding nanoscale amorphous carbons, and the weight of the corresponding composite NCM particle is 0.5:1:100.
